(19) United States
(12) Patent Application Publication
(10) Pub. No.: US 2011/0071762 A1
(43) Pub. Date: Mar. 24, 2011

(54) METHOD OF DETERMINING A TRANSIENT ELECTROMAGNETIC RESPONSE OF A FORMATION

(76) Inventor: Teruhiko Hagiwara, Houston, TX (US)

(21) Appl. No.: 12/919,054

(22) PCT Filed: Feb. 23, 2009
(86) PCT No.: PCT/US09/34849

§ 371 Date: Oct. 19, 2010

Related U.S. Application Data
(60) Provisional application No. 61/031,116, filed on Feb. 25, 2008.

(51) Int. Cl. G01V 3/38; G01V 3/12; G06F 19/00

(52) U.S. Cl. 702/6

(57) ABSTRACT

A system and method for determining an electromagnetic response from a region in an earth formation. Receivers where raw response signals (V_{raw}) are measured are at different offset distances (L1, L2) from a transmitter and are electromagnetically coupled to the transmitter by a support structure. The raw response signals (V_{raw}) are adjusted according to an exemplary method to provide an adjusted signal (V_{adj}). The effect of the support structure on the raw response signals (V_{raw}) is removed or reduced for the adjusted signal (V_{adj}) and the adjusted signal (v_{adj}) can be interpreted to determine information that is masked in each of the raw response signals (v_{raw}). The adjusted signal (v_{adj}) reflects the electromagnetic response from the region of the earth formation.

### TECHNICAL FIELD

This invention relates generally to signal processing in the context of geological exploration and, more specifically, to determining the transient electromagnetic response of a region of an earth formation.

### BACKGROUND

Electromagnetic investigation tools are often used to take measurements at points along the length of a borehole in an earth formation. In many instances, the tools are attached to or associated with a support structure such as a mandrel, bar, shaft, spindle, housing, cable or wire line. For example, in measuring while drilling (MWD) applications, also known as logging while drilling (LWD) applications, measurement tools may be attached to a high strength support structure that supports a drill bit as the drill bit forms a borehole. The high strength structure can cause the formation response measurements to be disrupted as the high strength structure is typically formed from an electrically conductive material, such as steel or another metal. Therefore, it is desirable to have a system and method that facilitate the removal or reduction of the contribution of the support structure to the measurement so as to reveal information that is provided by a formation response signal.

### SUMMARY

The various embodiments of the present invention overcome the shortcomings of the prior art by providing a system and method for determining an electromagnetic response from a region in an earth formation. Raw response signals are measured with receivers at different offset distances from one or more transmitters. The receivers are electromagnetically coupled to the one or more transmitters by a support structure. The raw signals are adjusted according to an exemplary method to provide an adjusted signal where the effect of the support structure on the raw response signals is removed or reduced. The adjusted signal can be interpreted to determine information that is masked in the raw response signals. In other words, the adjusted signal reflects the electromagnetic response from the region of the earth formation.

An exemplary method for determining an electromagnetic response from a region in an earth formation is now described. A measurement tool is conveyed into a borehole formed in the earth formation. The measurement tool can include multiple transmitters and multiple receivers. For example, the measurement tool can include a transmitter, a first receiver, and a second receiver, each positioned on or near an electrically conductive support structure. Here, the first receiver is positioned at a first distance from the transmitter and the second receiver is positioned at a second distance from the transmitter. One of the first receiver and the second receiver can be selected as a primary receiver and the other receiver can be selected as a secondary receiver, as described herein.

Once the measurement tool is positioned in the borehole, a source signal is transmitted from the transmitter. The source signal incites a first raw signal in the first receiver and a second raw signal in the second receiver. A data acquisition unit measures the first raw signal and the second raw signal and the raw signals are stored in a memory of a computing unit. The raw response signals exhibit an effect from the support structure coupling the transmitters to the receivers such that in a masked time interval the raw response signals do not reflect formation response signals.

The computing unit includes a processor unit that calculates an adjusted signal by determining a first function of the first raw signal, a second function of the second raw signal, a third function of the first distance, and a fourth function of the second distance. The third function and the fourth function relate the first function and the second function. The computing unit then modifies at least one of the first function and the second function according to the relationship between the third function and the fourth function and subtracts one of the resulting first and second functions from the other of the resulting first and second functions.

According to one aspect of the disclosure, the first function is the first raw signal, the second function is the second raw signal, the third function is the inverse of the first distance cubed, and the fourth function is the inverse of the second distance cubed.

According to another aspect of the disclosure, the first function is the first raw signal, the second function is the second raw signal, the third function is the average of the first raw signal over the masked time interval, and the fourth function is a the average of the second raw signal over the masked time interval.

In certain of the exemplary methods, a first reference signal and a second reference signal are respectively obtained at the first distance and the second distance in a reference medium having a resistivity that is higher than that of the region in the earth formation. For example, the reference medium can have a resistivity that is at least ten times that of the earth formation.

The computing unit can include memory that stores the first reference signal and the second reference signal.

According to an aspect of the disclosure, the first function is the first raw signal, the second function is the second raw signal, the third function is the first reference signal, and the fourth function is the second reference signal.

According to another aspect of the disclosure, the first function is a first calibrated signal that is determined by subtracting the first reference signal from the first raw signal, the second function is a second calibrated signal that is determined by subtracting the second reference signal from the second raw signal, the third function is the first distance, and the fourth function is the second distance.

According to another aspect of the disclosure, the first function is a first calibrated signal that is determined by subtracting the first reference signal from the first raw signal, the second function is a second calibrated signal that is determined by subtracting the second reference signal from the second raw signal, the third function is the average of the first calibrated signal over the masked time interval, and the fourth function is the average of the second calibrated signal over the masked time interval.

According to another aspect of the disclosure, the first function is a first calibrated signal that is determined by subtracting the first reference signal from the first raw signal, the second function is a second calibrated signal that is determined by subtracting the second reference signal from the second raw signal, the third function is the cube root of the first reference signal, and the fourth function is the cube root of the second reference signal.

The adjusted signal can be interpreted to determine information about the formation that is masked by the raw response signals. For example, the number of layers present in the region in the formation may be determined by calculating the slope of the adjusted signal in the masked time interval.

It is envisaged that the method can be performed by the system where computer executable instructions are contained on a computer readable medium. For example, a processor unit of the computing unit can execute the instructions.

The foregoing has broadly outlined some of the aspects and features of the present invention, which should be construed to be merely illustrative of various potential applications of the invention. Other beneficial results can be obtained by applying the disclosed information in a different manner or by combining various aspects of the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

FIG. 1 is an illustration of a system for determining an electromagnetic response from a region of an earth formation.

FIG. 2 is an illustration of the system of FIG. 1 in a homogenous region of the formation.

FIGS. 3 and 4 are illustrations of the system of FIG. 1 in two layer regions of the formation.

FIG. 5 is a graph illustrating signals relating to the homogeneous region of FIG. 2.

FIGS. 6 and 7 are graphs illustrating signals relating to the two layer regions of FIGS. 3 and 4.

FIG. 8 is a graph illustrating calibrated signals relating to the regions of FIGS. 2-4.

FIG. 9 is a graph illustrating adjusted signals relating to the regions of FIGS. 2-4.

### DETAILED DESCRIPTION OF THE INVENTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

Systems and methods are described herein in the context of determining a transient electromagnetic response in a region of an earth formation. The electromagnetic formation response can be interpreted to determine characteristics of the formation, such as the resistivity or conductivity of regions of the formation and the locations of boundaries. However, it is envisaged that the systems and methods taught herein can be applied to other environments and other parameters.

### Measurement System

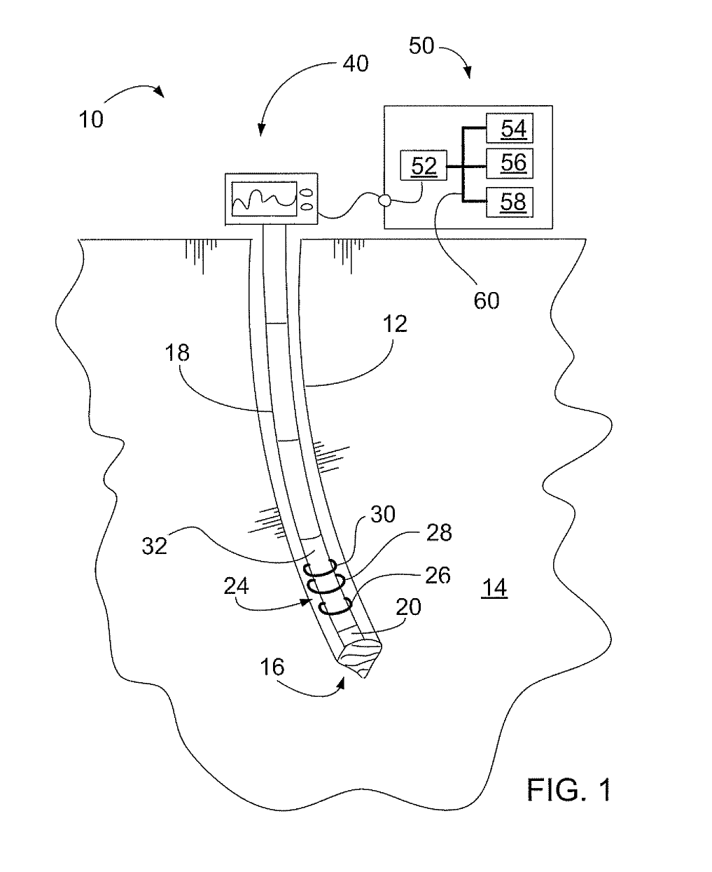

Referring to FIG. 1, a system 10 is configured to drill a borehole 12 in a formation 14 and to take measurements while drilling (MWD). In alternative embodiments, a borehole is drilled, the drill string is removed, and a measurement tool is then lowered into the borehole by a cable or other suitable suspension means.

To drill borehole 12, a drill bit 16 is positioned at the end of a series of tubular elements, referred to as a drill string 18. Drill bit 16 can be directed by a steering system 20, such as a rotatable steering system or a sliding steering system. In certain applications, measurements facilitate directing drill bit 16, for example, toward a hydrocarbon fluid reservoir.

System 10 includes a measurement tool 24 that is generally described as an array of transmitters and receivers and a corresponding support structure. In the illustrated embodiment, the support structure is a part of drill string 18. The support structure provides a foundation to which the transmitters and receivers are attached or otherwise houses the array. Hereinafter, the support structure will be described as a mandrel 32. However, the support structure could be any number of structures for supporting and positioning the array including a cable, housing, drill string element, combinations thereof, and the like.

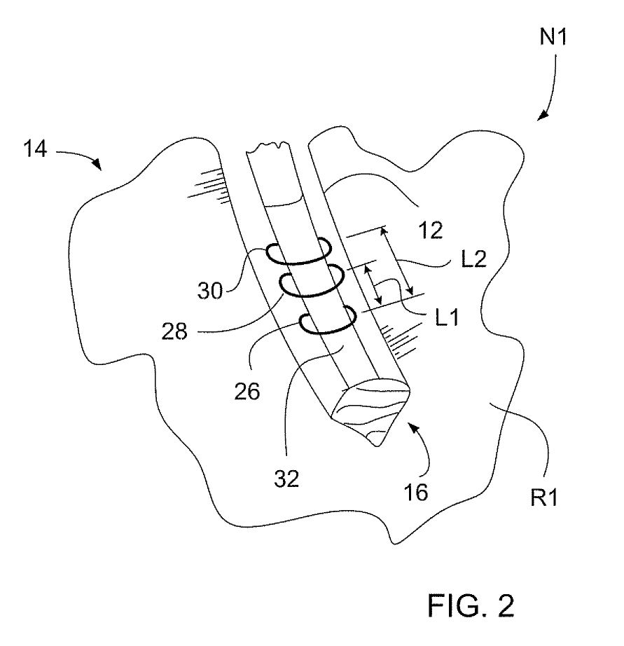

Illustrated measurement tool 24 includes a transmitter 26, a first receiver 28, and a second receiver 30 that are each positioned along the length of mandrel 32. As best shown in FIGS. 2-4, first receiver 28 is positioned at a first transmitter-receiver (TR) offset distance L1 from transmitter 26 and second receiver 30 is positioned at a second transmitter-receiver offset distance L2 from transmitter 26. In the exemplary embodiment, each of transmitter 26 and receivers 28, 30 includes a coil antenna that is wound around mandrel 32. Transmitter 26 and receivers 28, 30 are thereby arranged to be substantially coaxial. This arrangement is used for purposes of teaching. However, in alternative embodiments, transmitters and/or receivers can be multi-axial so as to send and receive signals along multiple axes. Further, in alternative embodiments, the measurement tool can include multiple transmitters and multiple receivers.

Generally described, a measurement tool includes a primary receiver and one or more secondary receivers. Various amounts of the responses from the secondary receivers are used to adjust the response of the primary receiver so as to minimize or reduce the mandrel effect, that is, the response due to electromagnetic coupling of transmitters and receivers by a mandrel or support structure. In other words, an adjusted signal can be the sum of the response of a primary receiver and responses of the secondary receivers where the responses of the secondary receivers are scaled, altered, or modified according to certain relationships.

In an exemplary embodiment described herein, first receiver 28 is selected as the primary receiver and second receiver 30 is selected as the secondary receiver. The formulations of adjusted signals reflect this selection. However, in alternative embodiments, second receiver 30 may be selected as the primary receiver and first receiver 28 may be selected as the secondary receiver.

System 10 further includes a data acquisition unit 40 and a computing unit 50. Data acquisition unit 40 controls output of transmitter 26 and collects the response at receivers 28, 30. The response and/or data representative thereof are provided to computing unit 50 to be processed according to the adjustment methods described herein. Computing unit 50 includes computer components including a data acquisition unit interface 52, an operator interface 54, a processor unit 56, a memory 58 for storing information, and a bus 60 that couples various system components including memory 58 to processor unit 56.

Computing unit 50 can be positioned at the surface or at a remote location such that information collected by measurement tool 24 while in borehole 12 is readily available. For example, a telemetry system can connect measurement tool 24, data acquisition unit 40, and computing unit 50. In alternative embodiments, data acquisition unit 40 and/or computing unit 50 is combined with or integral to measurement tool 24 and processes signals while in borehole 12.

### Method of Measuring a Transient Electromagnetic Response

An exemplary method of measuring an electromagnetic response of a region of formation 14 is now described. The response is measured with measurement tool 24. A transient electromagnetic (TEM) response is useful, for example, in deep reading electromagnetic (DEM) well logging applications to identify the boundaries and properties of layers of a region of a formation 14 at relatively large distances from borehole 12.

To begin, data acquisition unit 40 causes a current to flow through transmitter 26 so as to generate a magnetic field. The source signal or input to transmitter 26 may vary. According to an exemplary method, current is passed through transmitter 26 for a time that is long enough to induce a substantially stable magnetic field. This magnetic field permeates both the region of formation 14 and mandrel 32.

Then, the current is abruptly shut off and the changing magnetic fields of the region of formation 14 and mandrel 32 induce currents in receivers 28, 30. Signals that are measured at receivers 28, 30 over time are termed raw response signals V_{raw}. Raw response signals V_{raw} include contributions from both the region of formation 14 and mandrel 32. Raw response signals V_{raw} may be subjected to one or more operations such as noise suppression, pre-amplification, filtering, or transformation, prior to or as part of a method of adjusting the raw response signal.

In any event, mandrel 32 electromagnetically couples transmitter 26 to receivers 28, 30 so as to mask the electromagnetic response of the region of formation 14.

### Mandrel Effect Observed in Raw Signals

Referring to FIGS. 2-7, the effect of mandrel 32 is observed by comparing raw response signal V_{raw} to a formation response signal V_{f}, which represents the response of a region of formation 14 in the absence of mandrel 32. Formation response signal V_{f} is substantially fully attributed to the region of formation 14.

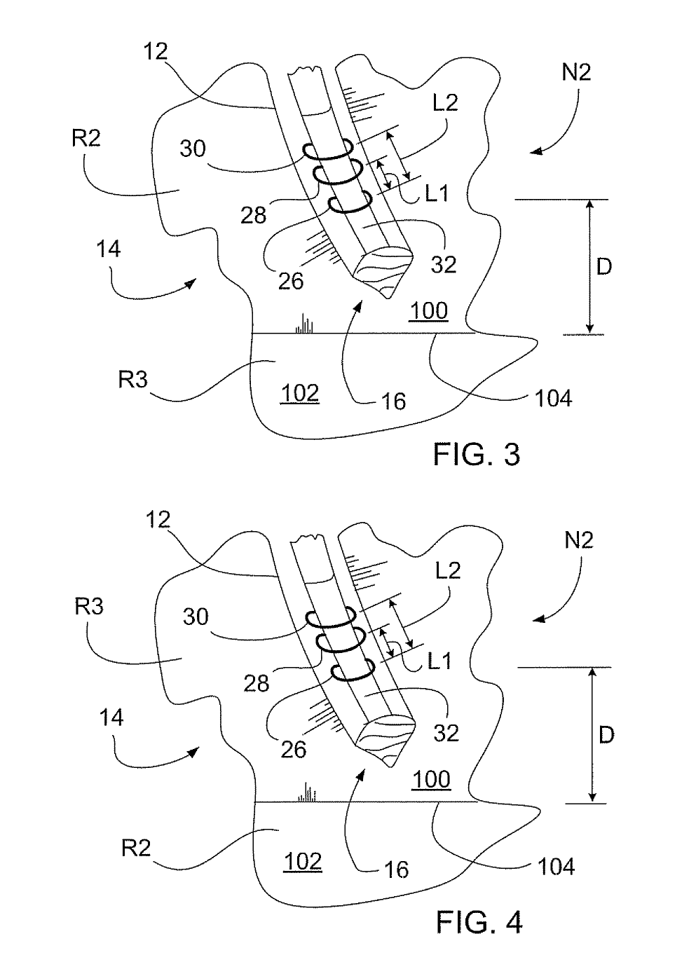

Referring to FIGS. 2-4, exemplary regions of the formation 14 are illustrated. FIG. 2 illustrates measurement tool 24 positioned in a homogeneous region N1 of formation 14 that has a resistivity R1. FIGS. 3 and 4 illustrate measurement tool 24 in a heterogeneous region N2 of formation 14 having two layers 100, 102. In FIG. 3, layers 100, 102 have resistivities R2, R3, respectively, and in FIG. 4, layers 100, 102 have resistivities R3, R2, respectively. For purposes of teaching, resistivity R3 is substantially greater than resistivity R2. A boundary 104 between layers 100, 102 is a distance D from measurement tool 24.

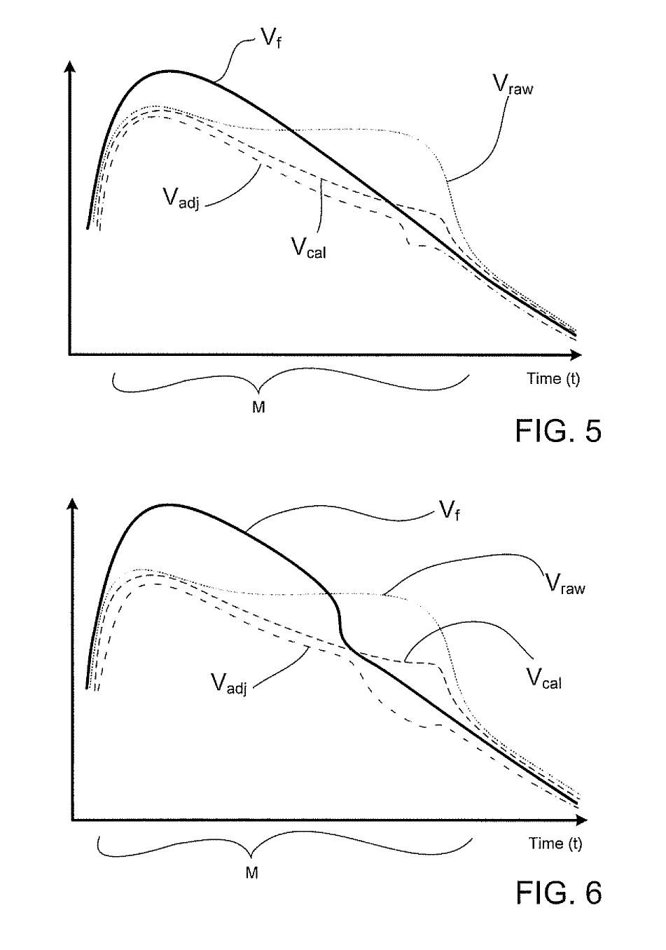

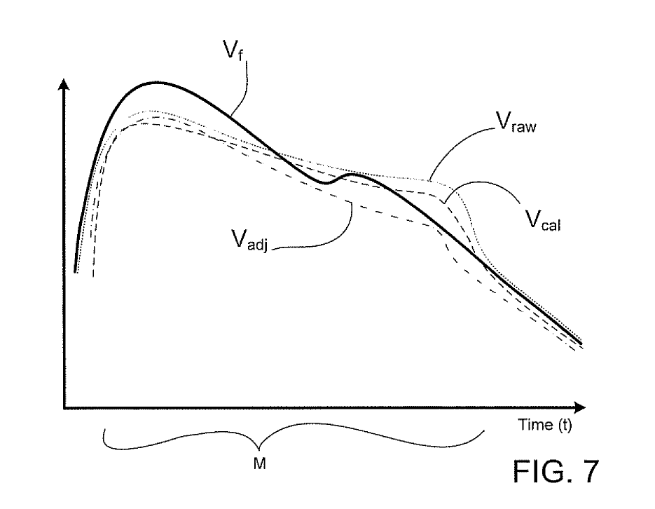

Raw response signal V_{raw} and formation response signal V_{f} illustrated in FIG. 5 relate to homogeneous region N1 of FIG. 2. Raw response signal V_{raw} and formation response signal V_{f} of FIG. 6 relate to heterogeneous region N2 of FIG. 3 where measurement tool 24 is positioned in first layer 100 having resistivity R2. Raw response signal V_{raw} and formation response signal V_{f} of FIG. 7 relate to heterogeneous region N2 of FIG. 4 where measurement tool 24 is positioned in first layer 100 having resistivity R3.

In each case, the contribution of mandrel 32 to raw response signal V_{raw} causes raw response signal V_{raw} to deviate from formation response signal V_{f}. Mandrel 32 contributes to raw response signal V_{raw} during a time interval that is referred to as a masked time interval M. For example, masked time interval M may be approximately 10⁻⁵s<t<10⁻²s.

At sufficiently late time, formation response signal V_{f} decays essentially as t^{-5/2} (when plotted on a double logarithmic graph). During masked time interval M, raw response signal V_{raw} decays substantially as t^{-1/2}. After the mandrel contribution dies out, raw response signal V_{raw} decays essentially as t^{-5/2} and reflects formation response signal V_{f}. Raw response signal V_{raw} may also reflect formation response signal V_{f} at times before masked time interval M depending on the resistivity of the formation.

### Adjustment Methods for Reducing the Mandrel Effect

During masked time interval M, it is difficult to interpret raw response signal V_{raw}, as raw response signal V_{raw} does not reflect formation response signal V_{f}. Adjustment methods can be applied to raw response signals V_{raw} to reduce the contribution of mandrel 32. Resulting adjusted signals V_{adj} better reflect formation response signals V_{f} or provide information about formation 14 that is present in the masked time interval M. Adjusted signals V_{adj} can be analyzed to facilitate determining the parameters of a model of formation 14, for example, the number of layers of formation 14. Generally, adjusted signals V_{adj} can be determined based on a relationship between raw response signals V_{raw} or between raw response signals V_{raw} and reference signals V_{ref}.

Reference signals V_{ref} that are used in certain methods of adjusting are now described. Reference signals V_{ref} are measured by receivers 28, 30 in a test environment. Typically, reference signals V_{ref} are collected to calibrate measurement tool 24 and are stored in memory 58. One example of a test environment is a substantially homogeneous reference medium that has a resistivity that is high relative to the resistivity of a region of formation 14 from which an electromagnetic response is to be determined. For example, the resistivity of a suitable test environment can be at least ten times greater than the resistivity of the region of formation 14. An example of a widely used test environment is air.

Reference signals V_{ref} are collected in the same manner as raw response signals V_{raw} with the difference being that reference signals V_{ref} are collected in a test environment and raw response signals V_{raw} are collected in a region of formation 14. Where the resistivity of the test environment is relatively high, the contribution of mandrel 32 to reference signal V_{ref} is relatively high compared to the contribution of the test environment. Thus, reference signal V_{ref} approximates the mandrel contribution.

Generally, the measurement tool that is used to obtain reference signals V_{ref} is the same that is used to measure raw response signals V_{raw}. Here, TR offset distances L1, L2 are the same in both the test environment and formation 14 to provide a relationship between reference signals V_{ref} and raw signals V_{raw} that have the same offset. In alternative embodiments, reference signals V_{ref} measured by one measurement tool can be used to adjust raw response signals V_{raw} measured by another measurement tool. For example, this may be acceptable where the different measurement tools have substantially equivalent conductive structures and arrays. In either case, reference signals V_{ref} and raw response signals V_{raw} that have the same offset can be related.

A calibrated signal V_{cal} that relates raw response signal V_{raw} and reference signal V_{ref} is now described. Calibrated signal V_{cal} is given by

V_{cal}(t)=V_{raw}(t)−V_{ref}(t).

Referring to FIGS. 5-7, calibrated signal V_{cal} reduces the dominant mandrel effect of raw response signal V_{raw} and decays essentially as t^{-3/2} for the masked time interval M. This decay is slower than that of formation response signal V_{f} and is nearly proportional to the formation conductivity σ_{f}.

Certain of the methods of adjusting are based on a relationship between raw response signals at different offset distances along the length of mandrel 32. These methods are termed “raw signal adjustment methods.” Other of the methods of adjusting are based on a relationship between calibrated signals at different offset distances along the length of mandrel 32. These methods are termed “calibrated signal adjustment methods.”

### Raw Signal Adjustment Methods

Relationships between raw response signals V_{raw} at different offset distances L1, L2 and corresponding raw signal adjustment methods are now described. Raw response signal V_{raw} measured by one of receivers 28, 30 depends not only on the resistivity of mandrel 32 and mandrel 32 geometry (e.g., diameter), but also strongly on TR offset distance L1, L2. Raw response signal V_{raw} is nearly independent of the TR offset distance L1, L2 if there is no mandrel 32. A combination of raw response signals V_{raw} measured at multiple TR offset distances L1, L2 can be used to reduce the mandrel effect and better reflect formation response signal V_{f}.

A first relationship between raw response signals V_{raw} measured at TR offset distances L1, L2 is now described. For large offsets, by comparing raw response signals V_{raw} measured at different TR offset distances L1, L2, it is observed that raw response signal V_{raw} is approximately inversely proportional to the cube of TR offset distance L1, L2. Thus, a large offset approximation of the relationship between raw response signal V_{raw} at first offset distance L1 and raw response signal V_{raw} at second offset distance L2 is given by

$$\frac{{V}_{raw} ( t , {L}_{1} )}{{V}_{raw} ( t , {L}_{2} )} \approx {( \frac{{L}_{2}}{{L}_{1}} )}^{3} .$$

As this relationship relates the contributions of mandrel 32 at different offsets L1, L2 but does not proportionally or directly relate the contributions of formation 14 at different offsets L1, L2, first adjusted signal V_{adj,1} can be determined whereby the first relationship is used to cancel out much of the mandrel contribution and better reflect formation response signal V_{f}. First adjusted signal V_{adj,1} is given by

$${V}_{adj , 1} ( t , {L}_{1} , {L}_{2} ) = {V}_{raw} ( t , {L}_{1} ) - {( \frac{{L}_{2}}{{L}_{1}} )}^{3} {V}_{raw} ( t , {L}_{2} ) .$$

For smaller TR offset distances L1, L2, the first relationship described above is less applicable. A second adjusted signal V_{adj,2} can be given by

V_{adj,2}(t,L₁,L₂)=V_{raw}(t,L₁)−P_{adj,2}(L₁,L₂)V_{raw}(t,L₂)

where modifying function P_{adj,2}(L₁,L₂) represents an observed or experimentally determined relationship found by analyzing the ratio of raw response signal V_{raw} at first offset distance L1 to raw response signal V_{raw} at second offset distance L2. For example, modifying function P_{adj,2}(L₁,L₂) can be determined by taking the average of the ratio over masked time interval M. In alternative embodiments, modifying function P_{adj,2}(L_{,},L₂) is also a function of time.

The first relationship described above is equally applicable to reference signals V_{ref} at different offset distances L1, L2. Accordingly, a third relationship between reference signals V_{ref} at offset distances L1, L2 and raw response signals V_{raw} at the same offset distances L1, L2 is given by

$$\frac{{V}_{raw} ( t , {L}_{1} )}{{V}_{raw} ( t , {L}_{2} )} \approx \frac{{V}_{ref} ( t , {L}_{1} )}{{V}_{ref} ( t , {L}_{2} )} .$$

This third relationship can similarly be used to provide a third adjusted signal V_{adj,3} that cancels out much of the mandrel contribution and reflects a formation signal. Third adjusted signal V_{adj,3} is given by

$${V}_{adj , 3} ( t , {L}_{1} , {L}_{2} ) = {V}_{raw} ( t , {L}_{1} ) - \frac{{V}_{ref} ( t , {L}_{1} )}{{V}_{ref} ( t , {L}_{2} )} {V}_{raw} ( t , {L}_{2} ) .$$

### Calibrated Signal Adjustment Methods

Relationships between calibrated signals V_{cal} at different offset distances L1, L2 and corresponding calibrated signal adjustment methods are now described. For large offset distances, it is observed that calibrated signal V_{cal} is approximately inversely proportional to offset distance L1, L2. For large offset distance, a fourth relationship between calibrated signal V_{cal} at first offset distance L1 and calibrated signal V_{cal} at second offset distance L2 is given by

$$\frac{{V}_{raw} ( t , {L}_{1} ) - {V}_{ref} ( t , {L}_{1} )}{{V}_{raw} ( t , {L}_{2} ) - {V}_{ref} ( t \cdot {L}_{2} )} = \frac{{V}_{cal} ( t , {L}_{1} )}{{V}_{cal} ( t , {L}_{2} )} \approx \frac{{L}_{2}}{{L}_{1}} .$$

A fourth adjusted signal V_{adj,4} that incorporates the fourth relationship is given by

$${V}_{adj , 4} ( t , {L}_{1} , {L}_{2} ) = {V}_{cal} ( t , {L}_{1} ) - \frac{{L}_{2}}{{L}_{1}} {V}_{cal} ( t , {L}_{2} ) .$$

Similar to the second adjusted signal V_{adj,2} above, a fifth adjusted signal V_{adj,6} can accordingly be given by

V_{adj,5}(t,L₁,L₂)=V_{cal}(t,L₁)−P_{adj,5}(L₁,L₂)V_{cal}(t,L₂)

where modifying function P_{adh,5}(L₁,L₂) represents an observed or experimentally determined relationship found by analyzing the ratio of calibrated signal V_{cal} at first offset distance L1 to calibrated signal V_{cal} at second offset distance L2.

Based on a relationship between first adjusted signal V_{adj,1} and third adjusted signal V_{adj,3}, a sixth adjusted signal V_{adj,6} can be similarly related to the fourth adjusted signal V_{adj,4}. Sixth adjusted signal V_{adj,6} is given by

$${V}_{adj , 6} ( t , {L}_{1} , {L}_{2} ) = {V}_{cal} ( t , {L}_{1} ) - {( \frac{{V}_{ref} ( t , {L}_{1} )}{{V}_{ref} ( t , {L}_{2} )} )}^{1 / 3} {V}_{cal} ( t , {L}_{2} ) .$$

A generalized adjustment signal V_{adj} that encompasses each adjustment signals V_{adj} is given by

$${V}_{adj} ( t , {L}_{1} , {L}_{2} ) = f 1 ( {V}_{raw} ( t , {L}_{1} ) ) - \frac{f 4 ( t , {L}_{2} )}{f 3 ( t , {L}_{1} )} f 2 ( {V}_{raw} ( t , {L}_{2} ) )$$

where f1 is a function of raw response signal V_{raw} at offset distance L1, f2 is a function of raw response signal V_{raw} at offset distance L2, f3 is a function of first distance L1, and f4 is a function of second distance L2. With respect to the adjusted signals described above, functions f1, f2 may be raw response signals V_{raw} or calibrated signals V_{cal} and functions f3, f4 may be offset distances L1, L2, reference signals V_{ref}, raw response signals V_{raw}, and variations thereof raised to an exponent. In any event, functions f3, f4 relate functions f1, f2 to one another.

Functions f3, f4 can be constant functions of offset distances L1, L2, respectively, or functions of both time and offset distances L1, L2, respectively.

Referring again to FIGS. 5-7, the graphs conceptually illustrate formation response signals V_{f}, raw response signals V_{raw}, calibrated signals V_{cal}, and adjusted response signals V_{adj} measured or calculated for each situation illustrated in FIGS. 2-4. For purposes of teaching, only one adjusted response signal V_{adj} is shown in each of FIGS. 5-7. Calibrated signal V_{cal} and adjusted response signal V_{adj} of each formation reduce the mandrel contribution of the raw response signal V_{raw} although neither fits formation response signal V_{f} during masked time interval M.

In general, during masked time interval M, raw response signals V_{raw} decay essentially as t^{-1/2}, calibrated signals V_{raw} decay essentially as t^{-3/2}, adjusted raw response signals V_{raw} decay essentially as t^{-3/2}, and adjusted calibrated response signals V_{cal} decay essentially as t^{-5/2}. For calibrated signals V_{cal} and adjusted signals V_{adj}, the mandrel contribution is particularly difficult to reduce toward the end of masked time interval M where deviations from a substantially constant decay are observed. The signals V_{cal}, V_{adj} may not provide useful information at this time although they can provide useful information at other times within and outside of masked time interval M.

### Interpretation of Adjusted Signal

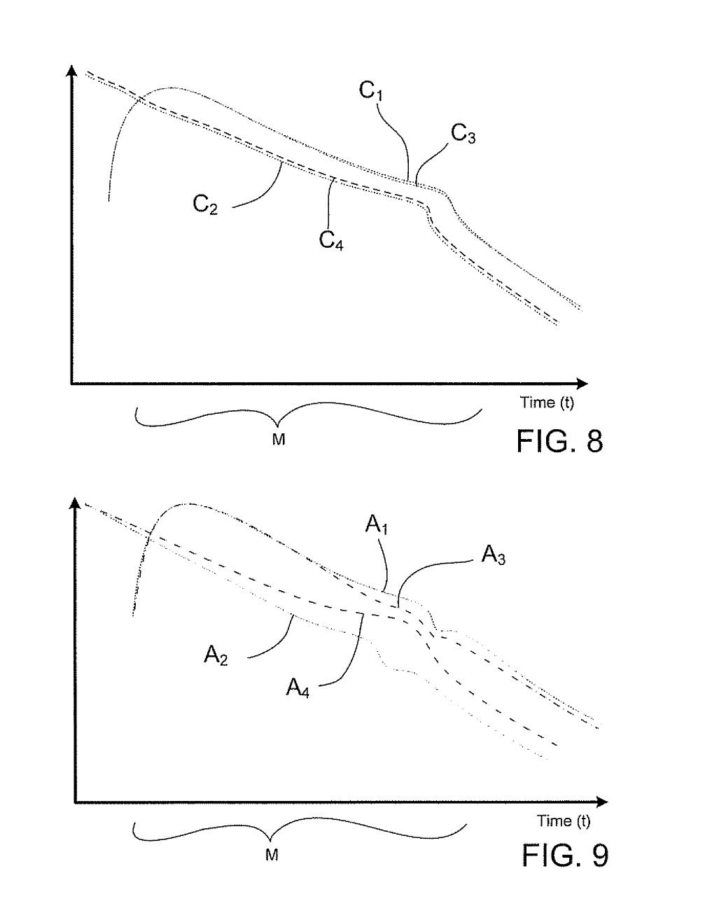

Within masked time interval M, adjusted response signal V_{adj} reflects formation response signal V_{f} better than calibrated signal V_{cal}. To illustrate this, referring first to FIG. 8, calibrated signals for V_{cal} comparing homogeneous and heterogeneous regions N1, N2 are shown on the same graph. Here, for purposes of clarity, calibrated signals V_{cal} will be represented with unique element numbers. A first calibrated signal C1 is determined from raw response signal V_{raw} measured in homogeneous region N1 where resistivity R1 is equal to resistivity R2. A second calibrated signal C2 is determined from raw response signal V_{raw} measured in homogeneous region N1 where resistivity R1 is equal to resistivity R3. A third calibrated signal C3 is determined from raw response signal V_{raw} measured in heterogeneous region N2 where measurement tool 24 is positioned in first layer 100 having resistivity R2, as shown in FIG. 3. A fourth calibrated signal C4 is determined from raw response signal V_{raw} measured in heterogeneous region N2 where measurement tool 24 is positioned in first layer 100 having resistivity R3, as shown in FIG. 4.

The difference between calibrated signals C2, C4 due to the different regions N1, N2 is mainly observed in the form of a shift of the overall response. As this difference is similar to the difference that is observed between calibrated signals C1, C2 due to the difference in resistivity R2, R3 in the same region N1, it is difficult to determine whether calibrated signal C4 represents heterogeneous region N2 or homogeneous region N1. In other words, the calibrated signal C3, C4 of heterogeneous region N2 may be wrongly interpreted as that of homogeneous region N1.

In the case of FIG. 4 where measurement tool 24 is located in the more conductive layer of heterogeneous region N2, a shift to less conductive layer is not readily observed. Accordingly, there is little difference between calibrated signals C1, C3. In either case, calibrated signal V_{cal} alone does not delineate the presence of a second layer.

Referring to FIG. 9, adjusted signals V_{adj} measured in different homogeneous and heterogeneous regions N1, N2 are shown on the same graph. Here, for purposes of clarity, adjusted signals V_{adj} will be represented with unique element numbers. A first adjusted signal A1 is determined from raw response signal V_{raw} measured in homogeneous region N1 where resistivity R1 is equal to resistivity R2. A second adjusted signal A2 is determined from raw response signal V_{raw} measured in homogeneous region N1 where resistivity R1 is equal to resistivity R3. A third adjusted signal A3 is determined from raw response signal V_{raw} measured in heterogeneous region N2 where measurement tool 24 is positioned in first layer 100 having a resistivity R2, as shown in FIG. 3. A fourth adjusted signal A4 is determined from raw response signal V_{raw} measured in heterogeneous region N2 where measurement tool 24 is positioned in first layer 100 having a resistivity R3, as shown in FIG. 4.

Here, the adjusted signals A3, A4 measured in heterogeneous regions N2 transition from the adjusted signals A1, A2 measured in homogeneous region N1 thereby clearly delineating the presence of a second layer. When measurement tool 24 is located in more a conductive layer, adjusted signal A3 is more difficult to distinguish from adjusted signal A1.

Without prior knowledge of region N1, N2 in which raw response signal V_{raw} is determined, raw response signal V_{raw} can be adjusted according to methods of adjusting described herein to provide adjusted response signal V_{adj}. Adjusted response signal V_{adj} at different points along the length of borehole 12 can be compared to one another to gain information about the formation 14 that is present in masked time interval M of each. For example, at one point along the length of the borehole, masked time interval M of adjusted response signal V_{adj} may have a certain slope in a substantially homogeneous region and, at another point along the length of borehole, masked time interval M of adjusted response signal V_{adj} may have a slope that transitions from that of the other adjusted response signal V_{adj} thereby indicating the presence of at least a second layer.

As the contribution of mandrel 32 has not been removed from adjusted signal V_{adj} toward the end of the masked time interval M, transitions from a constant slope line near this time may not delineate the presence of an additional layer.

The law does not require and it is economically prohibitive to illustrate and teach every possible embodiment of the present disclosure. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

1. A method for determining an electromagnetic response from a region in an earth formation, comprising:
a) conveying a measurement tool into a borehole formed in the earth formation, the measurement tool comprising a transmitter, a first receiver, and a second receiver, the first receiver and the second receiver being electromagnetically coupled to the transmitter by the support structure;
b) transmitting a source signal from the transmitter, thereby:
i) inciting a first raw signal (V_{raw}) in the first receiver, the first receiver being positioned at a first distance (L1) from the transmitter along the length of the electrically conductive support structure; and
ii) inciting a second raw signal (V_{raw}) in the second receiver, the second receiver being positioned at a second distance (L2) from the transmitter along the length of the electrically conductive support structure;
c) measuring the first raw signal (V_{raw}) and the second raw signal (V_{raw}); and
d) calculating an adjusted signal (V_{adj}) that approximates the electromagnetic response from the region of the earth formation at least in part by:
i) determining a first function (f1) of the first raw signal (V_{raw}) and a second function (f2) of the second raw signal (V_{raw});
ii) determining a third function (f3) of the first distance (L1) and a fourth function (f4) of the second distance (L2), wherein the third function (f3) and the fourth function (f4) relate the first function (f1) and the second function (f2);
iii) modifying at least one of the first function (f1) and the second function (f2) to relate the first function (f1) and the second function (f2) using the third function (f3) and the fourth function (f4); and
iv) subtracting one of the resulting first and second functions (f1, f2) from the other of the resulting first and second functions (f1, f2).

2. The method of claim 1, wherein the support structure contributes to the first raw signal (V_{raw}) and the second raw signal (V_{raw}) in a masked time interval (M).

3. The method of claim 2, wherein the first function (f1) is the first raw signal (V_{raw}), the second function (f2) is the second raw signal (V_{raw}), the third function (f3) is the average of the first raw signal (V_{raw}) over the masked time interval (M), and the fourth function (f4) is a the average of the second raw signal (V_{raw}) over the masked time interval (M).

4. The method of claim 1, wherein the first function (f1) is the first raw signal (V_{raw}), the second function (f2) is the second raw signal (V_{raw}), the third function (f3) is the inverse of the first distance (L1) cubed, and the fourth function (f4) is the inverse of the second distance (L2) cubed.

5. A computer readable medium comprising computer executable instructions adapted to perform the method of claim 1.

6. A system for determining an electromagnetic response from a region in an earth formation, comprising:
an electrically conductive support structure;
a measurement tool, comprising:
a transmitter for transmitting a source signal to incite an electromagnetic field in the region in the earth formation;
a first receiver for receiving a first raw signal (V_{raw}), the first receiver being positioned at a first distance (L1) from the transmitter;
a second receiver for receiving a second raw signal (V_{raw}), the second receiver being positioned at a second distance (L2) from the transmitter, the first receiver and the second receiver being electromagnetically coupled to the transmitter by the support structure;
a data acquisition unit for measuring the first raw signal (V_{raw}) and the second raw signal (V_{raw});
a memory for storing the first raw signal (V_{raw}) and the second raw signal (V_{raw});
a processor unit for executing instructions stored in the memory, the instructions comprising:
calculating an adjusted signal (V_{adj}) that approximates the electromagnetic response from the region of the earth formation at least in part by:
determining a first function (f1) of the first raw signal (V_{raw}) and a second function (f2) of the second raw signal (V_{raw});
determining a third function (f3) of the first distance (L1) and a fourth function (f4) of the second distance (L2), wherein the third function (f3) and the fourth function (f4) relate the first function (f1) and the second function (f2);
modifying at least one of the first function (f1) and the second function (f2) to relate the first function (f1) and the second function (f2) using the third function (f3) and the fourth function (f4); and
subtracting one of the resulting first and second functions (f1, f2) from the other of the resulting first and second functions (f1, f2).

7. The system of claim 6, wherein the memory stores a first reference signal (V_{ref}) and a second reference signal (V_{ref}) that are respectively obtained by the first receiver and the second receiver in a reference medium having a resistivity that is higher than that of the region in the earth formation.

8. The system of claim 7, wherein the first function (f1) is a first calibrated signal (V_{cal}) that is determined by subtracting the first reference signal (V_{ref}) from the first raw signal (V_{raw}), the second function (f2) is a second calibrated signal (V_{cal}) that is determined by subtracting the second reference signal (V_{ref}) from the second raw signal (V_{raw}), the third function (f3) is the first distance (L1), and the fourth function (f4) is the second distance (L2).

9. The system of claim 7, wherein the support structure contributes to the first raw signal (V_{raw}) and the second raw signal (V_{raw}) in a masked time interval (M);
wherein the first function (f1) is a first calibrated signal (V_{cal}) that is determined by subtracting the first reference signal (V_{ref}) from the first raw signal (V_{raw}), the second function (f2) is a second calibrated signal (V_{cal}) that is determined by subtracting the second reference signal (V_{ref}) from the second raw signal (V_{raw}), the third function (f3) is the average of the first calibrated signal (V_{cal}) over the masked time interval (M), and the fourth function (f4) is the average of the second calibrated signal (V_{cal}) over the masked time interval (M).

10. The system of claim 6, wherein the first function (f1) is the first raw signal (V_{raw}), the second function (f2) is the second raw signal (V_{raw}), the third function (f3) is the inverse of the first distance (L1) cubed, and the fourth function (f4) is the inverse of the second distance (L2) cubed.
